(19) United States
(12) Patent Application Publication
(10) Pub. No.: US 2013/0215355 A1
(43) Pub. Date: Aug. 22, 2013

(54) BACKLIGHT MODULE AND LIQUID CRYSTAL DISPLAY USING THE SAME

(71) Applicants: HOU-TE LIN, Hukou (TW); CHAO-HSIUNG CHANG, Hukou (TW)

(72) Inventors: HOU-TE LIN, Hukou (TW); CHAO-HSIUNG CHANG, Hukou (TW)

(73) Assignee: ADVANCED OPTOELECTRONIC TECHNOLOGY, INC., Hsinchu Hsien (TW)

(21) Appl. No.: 13/471,461

(22) Filed: May 15, 2012

(30) Foreign Application Priority Data
Feb. 20, 2012 (CN) 201210037709.X

(51) Int. Cl. G02F 1/1333; G09F 13/04

(52) U.S. Cl. 349/58; 362/97.1

(57) ABSTRACT

A backlight module includes a mounting plate and plural light-emitting diodes mounted on the mounting plate. The mounting plate includes plural ridges. Each of the ridges is strip-shaped and includes two mounting walls each extending inclinedly and upwardly from a corresponding connecting portion. An obtuse angle is formed between each of the mounting walls and the corresponding connecting portion. The light-emitting diodes are mounted on the mounting walls of the ridges, whereby the light-emitting diodes are tilted relative to connecting portions. The present disclosure further discloses a liquid crystal display using the backlight module. The light-emitting diodes face upwardly and inclinedly toward a liquid display screen of the display when the backlight module is located below the screen.

### BACKGROUND

1. Technical Field

The present disclosure generally relates to backlight modules, and particularly to a backlight module with a folded back plate and a liquid crystal display (LCD) using the backlight module.

2. Description of Related Art

With progress in electronic technology and the popularization of portable electronic devices in daily life, demands for display of light weight and low power consumption have been increased. Therefore, liquid crystal display (LCD) has gradually replaced the cold cathode-ray tube (CRT) display in modern information products such as portable computers, mobile phones and personal digital assistants (PDAs), based on its advantages of low power consumption, low heat emission, light weight and non-radiation. Because liquid crystal displays are not self-illuminant, backlight modules are provided to illuminate the displays.

A conventional backlight module includes a flat back plate and a plurality of light-emitting diodes (LEDs) mounted on the back plate in array. To decrease a cost of the backlight module, the number of the light-emitting diodes is reduced to the minimum. Under this requirement, each of the light-emitting diodes should be provided with a lens at a light output side thereof to make the light illumination field generated by each light-emitting diode be as large as possible, whereby the defects of spots and mura on a liquid display screen of the LCD can be avoided. However, the lens simultaneously increases the cost and the volume of the LED and accordingly the backlight module.

What is needed, therefore, is a backlight module and a liquid crystal display using the same which can overcome the limitations described.

### BRIEF DESCRIPTION OF THE DRAWINGS

FIG. 1 is a schematic view of a backlight module in accordance with a first embodiment of the present disclosure.

FIG. 2 is a schematic view illustrating an exemplary application of the backlight module of FIG. 1.

FIG. 3 is a schematic view of a backlight module in accordance with a second embodiment of the present disclosure.

FIG. 4 is a schematic view of a backlight module in accordance with a third embodiment of the present disclosure.

### DETAILED DESCRIPTION

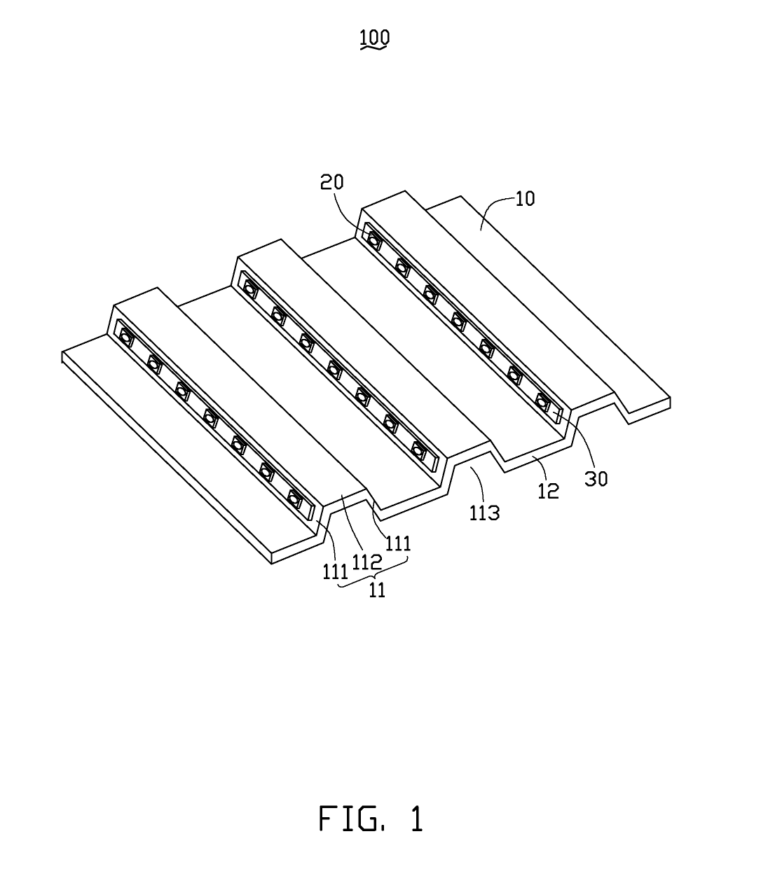

Referring FIG. 1, a backlight module 100 in accordance with a first embodiment of the present disclosure is shown. The backlight module 100 includes a mounting plate 10 and a plurality of light-emitting diodes 20 mounted on the mounting plate 10.

The mounting plate 10 is substantially wave-shaped. The mounting plate 10 includes a plurality of ridges 11 and a plurality of connecting portions 12 each connecting with two adjacent ridges 11. Each of the ridges 11 is strip-shaped and extends along a periphery of a trapezium. Each of the ridges 11 includes two mounting walls 111 extending inclinedly upwardly from two neighboring connecting portions 12 toward each other and facing each other and a top wall 112 connecting top ends of the two mounting walls 111. The mounting walls 111 and the top wall 112 cooperatively define a trapeziform ditch 113 beneath the ridge 11. The two mounting walls 111 of each of the ridges 11 are tilted towards each other, and an obtuse angle is formed between each of the mounting walls 111 and a connecting portion 12 in connection therewith. The top walls 112 and the connecting portions 12 are flat and strip-shaped, and parallel to each other.

The light-emitting diodes 20 are mounted on a plurality of mounting bars 30 each having a shape of an elongated stripe and each having circuitry formed thereon. The light-emitting diodes 20 on each mounting bar 30 are arranged in a line. Each of the mounting bars 30 is mounted on one of the mounting walls 111 of the ridges 11. The mounting bar 30 substantially conformably covers an exterior surface of the ridge 11 on which the mounting bar 30 is mounted. Since the mounting walls 111 of the ridges 11 are tilted, the light-emitting diodes 20 mounted on the mounting walls 111 are tilted and face inclinedly upwardly. Alternatively, the light-emitting diodes 20 can be mounted on the mounting walls 111 of the ridges 11 directly. In this condition, circuitry should be formed on the mounting plate 10 directly.

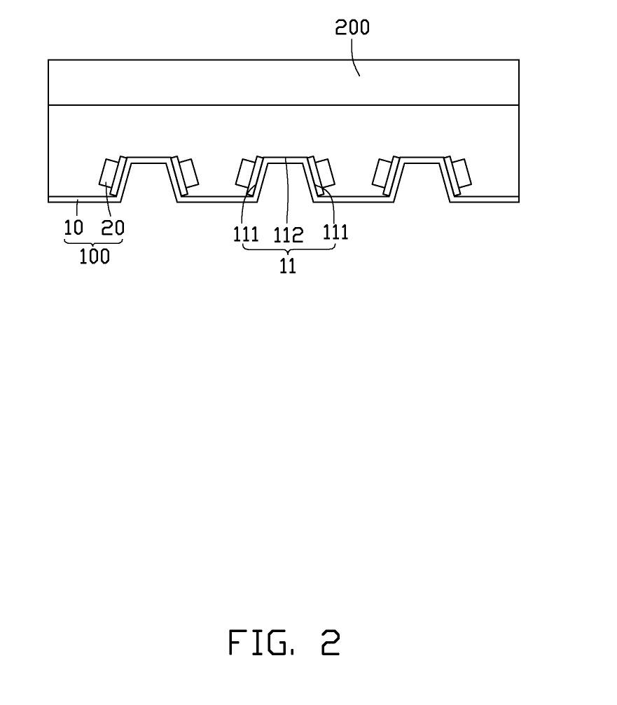

FIG. 2 shows an exemplary application of the backlight module 100, wherein the backlight module 100 is used as a backlight source of a liquid crystal screen 200. The backlight module 100 is mounted behind the liquid crystal screen 200 with the light-emitting diodes 20 thereof oriented toward the liquid crystal screen 200. The liquid crystal screen 200 is parallel to the top walls 112 and the connecting portions 12. Since the mounting walls 111 are tilted relative to the connecting portions 12, the light-emitting diodes 20 mounted on the mounting walls 111 are tilted relative to the liquid crystal screen 200. Therefore, each of the light-emitting diodes 20 illuminates a larger area on the liquid crystal screen 200 than a conventional light-emitting diode without an optical lens which illuminates a liquid crystal screen perpendicularly. The present disclosure also promotes an even illumination of the light-emitting diodes 20 on the liquid crystal screen 200.

In the backlight module 100, the ridges 11 are devised to widening an illuminating area of the light-emitting diodes 20 on the liquid crystal screen 200 instead of using lenses; thus, the cost of the backlight module 100 can be reduced.

Furthermore, each of the ridges 11 protrudes out of the mounting plate 10 and further defines a corresponding ditch 113 therein. This not only increases a heat dissipation area of the mounting plate 10, but also readily facilitates air convection through the mounting plate 10 during operation of the backlight module 100. Accordingly, heat generated by the light emitting diodes 20 can be effectively dissipated, which is vital to the stability of operation and life of use of the light emitting diodes 20.

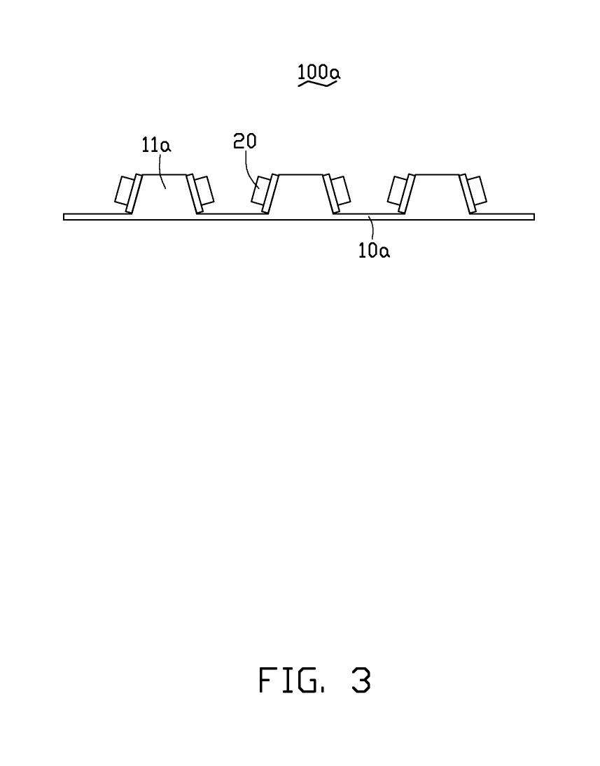

FIG. 3 illustrates a backlight module 100a in accordance with a second embodiment of the present disclosure. The backlight module 100a is similar to that of the first embodiment but differs from that of the first embodiment in ridge 11a. The ridge 11a of the backlight module 100a is solid. This strengthens the mounting plate 10a of the backlight module 100a.

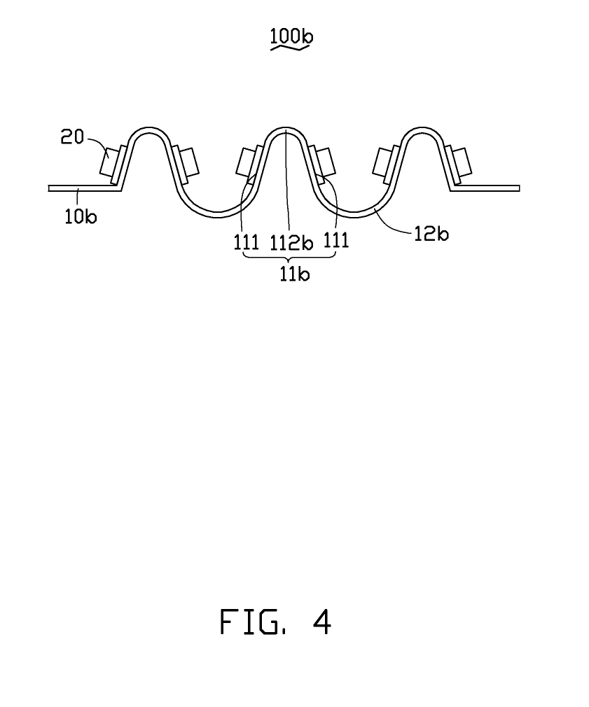

FIG. 4 illustrates a backlight module 100b in accordance with a third embodiment of the present disclosure. The backlight module 100b is similar to that of the first embodiment but differs from that of the first embodiment in ridges 11b and connecting portions 12b of the mounting plate 10b between every two adjacent ridges 11b. In the backlight module 100b, the top wall 112b of the ridge 11b is arc-shaped, and the connecting portion 12b is also arc-shaped. A cross section of the mounting plate 10b of the backlight module 100b, except the two opposite mounting extremities, has a sine-wave shape.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. A backlight module comprising:
a mounting plate comprising a plurality of ridges, each of the ridges comprising two mounting walls each extending inclinedly and upwardly from a corresponding connecting portion, an obtuse angle being formed between each of the mounting walls and the corresponding connecting portion; and
a plurality of light-emitting diodes mounted on the mounting walls of the ridges, whereby the light-emitting diodes are tilted upwardly relative to the connecting portions.

2. The backlight module of claim 1, wherein the mounting plate is wave-shaped.

3. The backlight module of claim 1, wherein each of the ridges is stripe-shaped and protrudes upwardly in relative to the connecting portions.

4. The backlight module of claim 3, wherein each of the ridges extends along a periphery of a trapezium.

5. The backlight module of claim 4, wherein each of the connecting portions has one of following shapes: flat and arc-shaped.

6. The backlight module of claim 1, wherein each of the ridges further comprises a top wall connecting top ends of the two mounting walls thereof, and the top wall has one of following shapes: flat and arc-shaped.

7. The backlight module of claim 6, wherein the two mounting walls and the top wall of each of the ridges cooperatively define a ditch beneath the each of the ridges for facilitating air convection through the mounting plate.

8. The backlight module of claim 1, wherein each of the ridges is solid.

9. A liquid crystal display comprising:
a liquid crystal screen; and
a backlight module positioned below the liquid crystal screen, the backlight module comprising a mounting plate a plurality of light-emitting diodes mounted on the mounting plate, the mounting plate comprising a plurality of ridges and a plurality of connecting portions each connecting with two neighboring ridges, each of the ridges comprising two mounting walls, each of the mounting walls facing inclinedly and upwardly toward the liquid crystal screen, the light-emitting diodes being mounted on the mounting walls of the ridges and facing inclinedly and upwardly toward the liquid crystal screen.

10. The liquid crystal display of claim 9, wherein the mounting plate is wave-shaped.

11. The liquid crystal display of claim 9, wherein each of the ridges protrudes upwardly from two of the connecting portions in connection therewith.

12. The liquid crystal display of claim 11, wherein each of the ridges is stripe-shaped and extends along a periphery of a trapezium.

13. The liquid crystal display of claim 12, wherein each of the connecting portion has one of following shapes: flat and arc-shaped.

14. The liquid crystal display of claim 9, wherein each of the ridges further comprises a top wall connecting top ends of the two mounting walls thereof, and the top wall has one of following shapes: flat and arc-shaped.

15. The liquid crystal display of claim 14, wherein the two mounting walls and the top wall of each of the ridges cooperatively define a ditch beneath the each of the ridges.

16. The liquid crystal display of claim 9, wherein each of the ridges is solid.
